(19) United States
(12) Patent Application Publication
(10) Pub. No.: US 2019/0034954 A1
(43) Pub. Date: Jan. 31, 2019

(54) SYSTEM AND METHOD FOR INTEGRATED MANAGEMENT OF LOYALTY POINTS

(71) Applicants: Soo Hyang Kang, Brea, CA (US); Nam Joo Kim, Seoul (KR)

(72) Inventor: Nam Joo KIM, Seoul (KR)

(21) Appl. No.: 15/665,333

(22) Filed: Jul. 31, 2017

(51) Int. Cl. G06Q 30/02; G06K 19/077

(52) U.S. Cl. CPC G06Q 30/0227; G06K 19/07703; G06Q 30/0233; G06Q 30/0229

(57) ABSTRACT

A computer-implemented integrated loyalty points management system and method includes a plurality of affiliate servers, an integrated loyalty points management server, and a loyalty pool. The affiliate servers may process purchases of loyalty points for issuing to customers. Loyalty points may be integrated loyalty points, which are issued by each of the affiliates for a purchase or purchases made by a customer. Any of the affiliate servers may process redemption of loyalty points by customers for goods, services, or money. The affiliate server may communicate with the integrated loyalty points management server and the loyalty pool to exchange redeemed loyalty points for cash.

### FIELD OF THE INVENTION

This invention relates to systems and methods for management of loyalty points issued to customers, and in particular to systems and methods for earning, exchanging, issuing, and redeeming loyalty points.

### BACKGROUND OF THE INVENTION

Traditional loyalty points programs provide an incentive for customers to purchase goods or services from a particular merchant. For example, a coffee shop may issue a loyalty point for a beverage purchase; after accumulating a set number of loyalty points, such points may be redeemed for a free beverage. The loyalty points program provides the customer a free beverage in exchange for repeat business, which benefits the coffee shop. Additionally, the merchant may promote a loyalty points program to attract new customers.

Similar incentives-laden loyalty points programs are prevalent in a wide variety of industries and offered by merchants such as commercial airlines, hotels, restaurants, grocery stores, department stores, various online retailers, and more. A loyalty point in these various forms may alternatively be referred to as a “mileage point,” a “reward point,” a “point,” a “star,” a “reserve point,” “cyber money” or the like. In the present specification, “loyalty point” is used to encompass these various forms of reward for purchases.

Since one of the incentives to merchants offering loyalty points is to attract customers to their own business, loyalty points are generally very limited. For example, loyalty points offered through a business's website may only be earned by shopping on that website. Additionally, any loyalty points earned by shopping on the website may only be redeemable through the same website. In general, in order to redeem loyalty points, a predetermined amount of loyalty points must be accumulated through purchases. For customers who only make occasional purchases on the website, accumulating the predetermined amount of loyalty points may be difficult and the loyalty points program itself may be useless.

Another limitation of traditional loyalty points systems is that loyalty points issued by one merchant may generally not be transferred or combined with loyalty points issued by another merchant. Such a limitation makes redeeming loyalty points more difficult for the customer, which may cancel out any incentive the customer has to make purchases from the merchant.

A merchant who wishes to introduce a loyalty points program may find the task of developing and managing a sophisticated loyalty point program to be burdensome. Small businesses having limited resources may be especially disadvantaged in this regard.

Several technologies have been developed to address the shortcomings of traditional loyalty points programs. Korean Patent No. 10-0366150 (“first prior art”) discloses a method for managing loyalty points in internet-based electronic commerce. The points disclosed in the first prior art may be used to purchase products from various websites. The first prior art utilizes a management server connected through the internet to a plurality of users and a plurality of participating websites. Accordingly, an internet accessible device may be used to make purchases. The methods according to the first prior art are illustrated in FIGS. 1-3.

However, the advantages of the first prior art are very limited. For example, the loyalty points earned by a customer have very restricted redemptive value. Even though the points may be redeemed at various websites, they are only redeemable for specific items or services, which the customer may not need or desire.

Another centralized loyalty points management system according to another prior art disclosure, as shown in FIG. 4, may include a central loyalty points management system, which collects customer information in a centralized database and various service providers subscribe to a centralized loyalty points system. Such a centralized loyalty points management minimizes the role of the subscribing service providers, who must follow the loyalty point policy of the centralized loyalty points management system. Accordingly, subscribing service providers are limited in their capacity to customize such loyalty points systems for their own needs. Additionally, the centralized customer database may become difficult to manage if the number of subscribing service providers becomes large.

### SUMMARY OF THE INVENTION

The present invention contrives to solve the problems of the prior art. The invention provides a computer implemented system and method to integratedly manage loyalty points for a plurality of affiliates.

In particular, the system may include an affiliate server of each affiliate managing a customer database having customer information for the affiliate. Each affiliate server may process issuing and redemption of loyalty points. The system May also include an integrated loyalty points management server, which communicates with the plurality of affiliate servers and manages an integrated customer database of the affiliate customer databases. The integrated loyalty points management server may also communicate with the affiliate server to manage the loyalty points earned by customers of the affiliate. The system may also include a loyalty pool, which communicates with the integrated loyalty points management server and affiliate server to process money deposits and withdrawals by affiliate servers.

The loyalty points may be integrated loyalty points, wherein each affiliate issues integrated loyalty points and accepts redemption of integrated loyalty points. The affiliate server may process a purchase of loyalty points by depositing money to the loyalty pool; upon authentication of the deposit, the integrated loyalty points management server may issue loyalty points to the affiliate server. The loyalty points may then be issued by affiliates to customers for purchases.

Accordingly, the loyalty points may have a monetary value and may be redeemed by a customer from an affiliate for goods, services, or cash. The affiliate server may communicate with the integrated loyalty points management server a request to exchange the redeemed loyalty points for cash. Upon certifying authenticity of the loyalty points, the integrated loyalty points management server may communicate the certification to the loyalty pool. The loyalty pool may then transfer money to the affiliate; the amount of money transferred may correspond to the monetary value of the redeemed loyalty points.

The system for integrated management of loyalty points may include secondary affiliates, who redeem loyalty points but do not issue loyalty points. Secondary affiliates may exchange redeem loyalty points for cash.

The system for integrated management of loyalty points may include tertiary affiliates, who do not redeem loyalty points but do issue loyalty points for purchases. Tertiary affiliates may purchase loyalty points for cash.

Customers may store loyalty points, including integrated loyalty points, on a personal electronic device, such as a smart card, having a non-transitory computer-readable data storage medium. Other customer information may be stored on the data storage medium. Customer information may be synced with the customer database of the affiliates, which may also be integrated with the integrated customer database.

The smart card may also have a digital display, wherein a loyalty points balance may be displayed.

The advantages of the present invention are: the integrated loyalty points management system incentivizes customers to make purchases from affiliates, because the loyalty points issued does not necessarily need to be redeemed at a particular affiliate; depending on business needs, a merchant or service provider may participate as an affiliate, secondary affiliate, or a tertiary affiliate; and the invention provides secure and efficient methods for issuing and redeeming loyalty points.

### BRIEF DESCRIPTION OF THE DRAWINGS

FIG. 1 is a schematic block diagram illustrating a loyalty points system in which multiple subjects are connected to an Internet network according to the prior art.

FIG. 2 is a schematic diagram illustrating a procedure to purchase mileage from an integrated mileage management server and provides the mileage to a user who purchases an item on a website according to the prior art.

FIG. 3 is a schematic view illustrating a system when an Internet user uses the mileage received from a website according to the prior art.

FIG. 4 is a schematic block diagram of a centralized loyalty integrated management system according to the prior art.

FIG. 5 is a schematic block diagram of a system for integrated management of loyalty points according to an exemplary embodiment of the present invention.

FIG. 6 is a diagram describing payment certification by the integrated loyalty points management system according to the first embodiment of the present invention.

FIG. 7 is a diagram illustrating flow of integrated loyalty points according to the first embodiment of the present invention.

FIG. 8A is a diagram of a network for an integrated loyalty points management system according to the present invention.

FIG. 8B is another diagram of a network for an integrated loyalty points management system according to the present invention.

FIG. 9 is a schematic view of the system for integrated management of loyalty points illustrating a role of the loyalty pool.

FIG. 10 is a schematic view for describing an embodiment of the invention including a smart card.

FIG. 11 is a schematic view illustrating an embodiment of the invention in which the system for integrated management of loyalty points includes electronic money.

FIG. 12 is a schematic view illustrating a payment process in a method for integrated management of loyalty points according to the present invention.

FIG. 13 illustrates one example of a configuration for Internet connection of the system for integrated management of loyalty, points according to the present invention.

FIG. 14 is a schematic view illustrating matters regarding security of the system for integrated management of loyalty points according to the present invention.

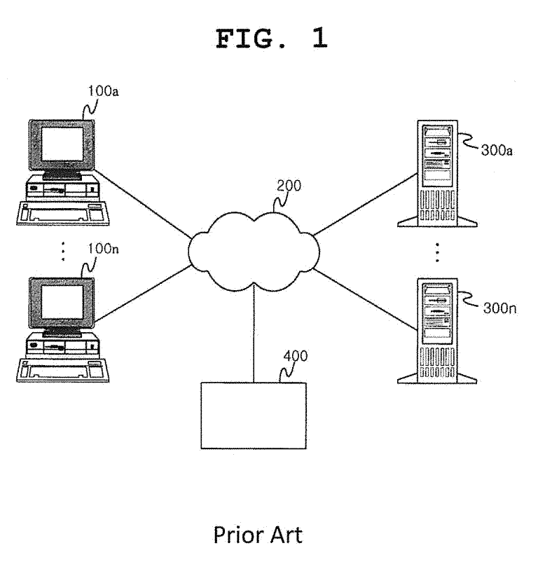

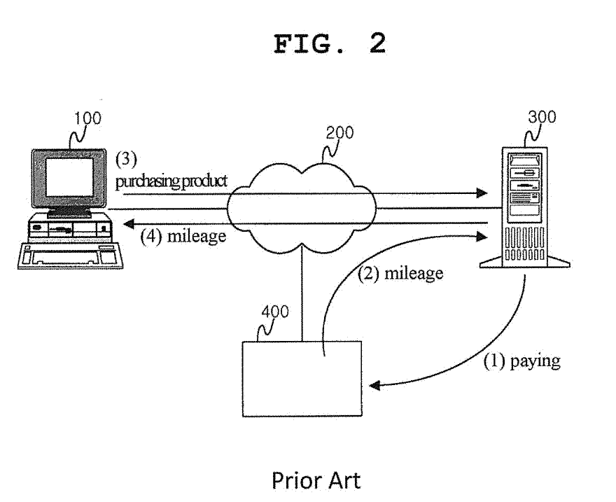

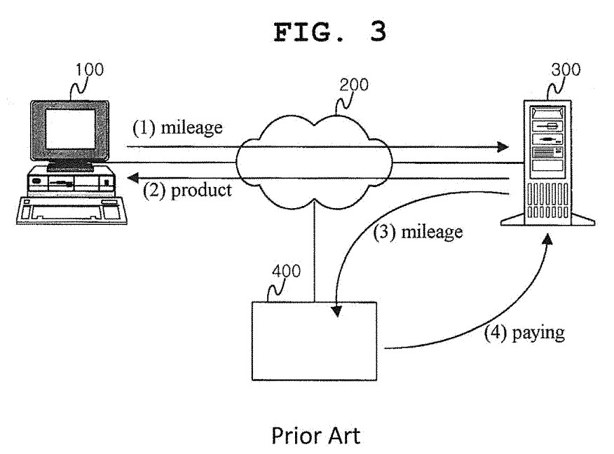

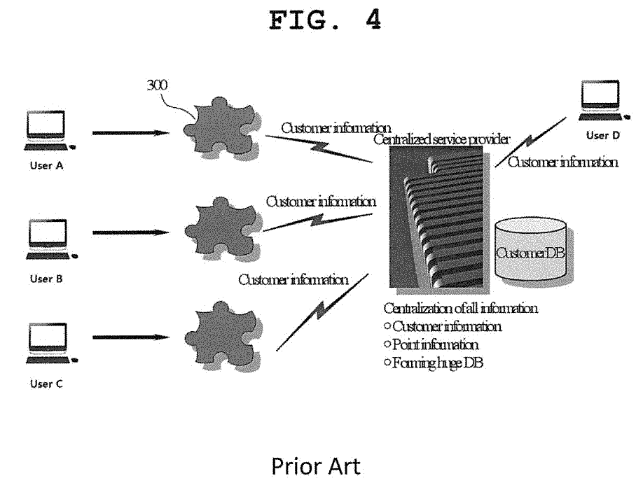

### DETAILED DESCRIPTION OF THE EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges May be expressed herein as from “about” or “approximately” one particular value and/or to “about” or “approximately” another particular value. When such a range is expressed, another embodiment includes from the one particular value and/or to the other particular value. Similarly, when values are expressed as approximations by use of the word “about”, it will be understood that the particular value forms another embodiment.

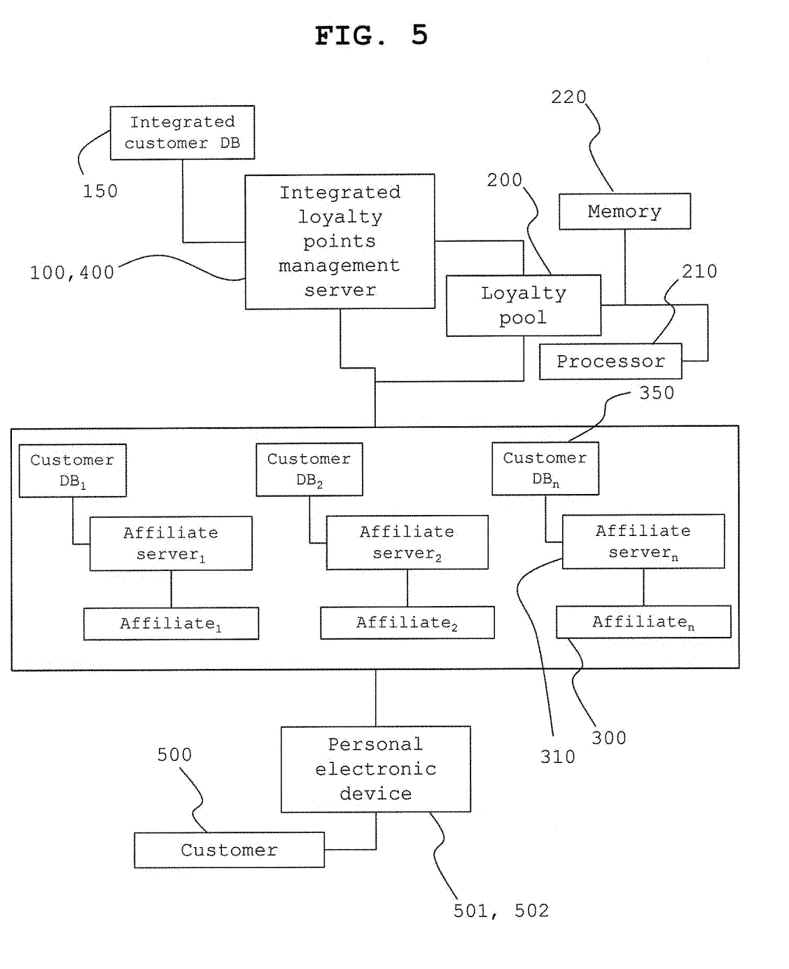

As shown in FIG. 5, according to one embodiment of the present invention, a system for integrated management of loyalty points may include a plurality of primary affiliate servers 310, an integrated loyalty points management server 100, 400, and a loyalty pool 200.

Each primary affiliate server 310 may be associated with a corresponding primary affiliate 300. Herein, an affiliate 300, 300′, 300″ may be a merchant, service provider, or another business participating in the integrated loyalty management program.

A server may include a processor and a non-transitory computer-readable medium. A server may communicate with another server through one of a variety of networks.

Each primary affiliate server 310 may manage a customer database (DB) 350 of the primary affiliate 300 stored on the computer-readable medium. As customer information is updated, the primary affiliate server 200 may update the customer DB 350 accordingly.

The primary affiliate server 310 may communicate with the integrated loyalty points management server 100, 400 a purchase request for purchasing a predetermined amount of integrated loyalty points and transmit a deposit to the loyalty pool 200. The loyalty pool 200 may confirm the deposit to the integrated loyalty points management server 100, 400, and the loyalty points management server 100, 400 may issue the predetermined amount of integrated loyalty points to the primary affiliate 300. Accordingly, a secure method of transferring integrated loyalty points to be issued by the primary affiliate 300 may be achieved.

Integrated loyalty points earned by the customer 500 through transactions from the primary affiliate 300 may be recorded on a data storage medium of a personal electronic device 501, 502 of the customer 500. The personal electronic device may be a smartphone, a computer tablet, or the like. Preferably, the personal electronic device may be a smart card 501.

The smart card 501 may have a display. The smart card may include input buttons and a digital display, which may display an integrated loyalty points balance.

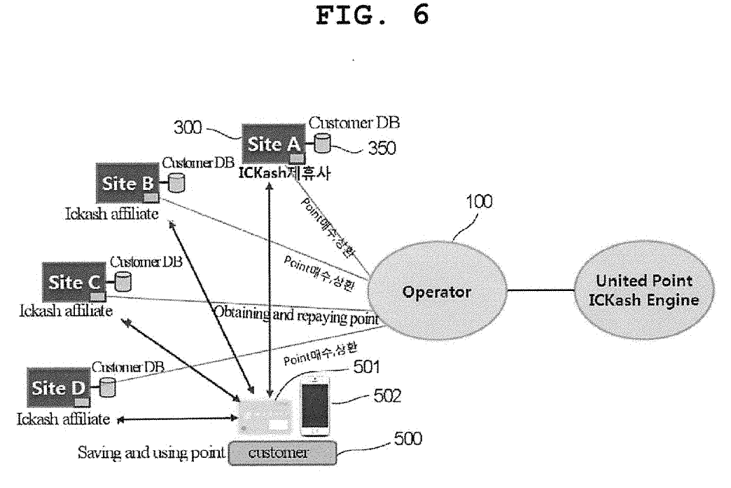

The integrated loyalty points management server 100, 400 may communicate with the primary affiliate servers 310 and manage an integrated customer database 350. As shown in FIG. 6, the integrated loyalty points management server 100, 400 may manage integrated loyalty points issued to customers 500, wherein each primary affiliate 300 issues integrated loyalty points according to a policy of the primary affiliate 300.

Herein, the integrated loyalty points may be referred to as ICKash™.

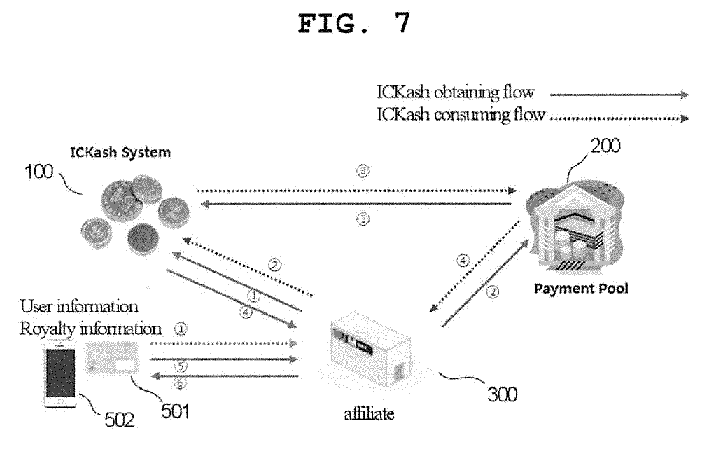

FIG. 7 diagrams the flow of integrated loyalty points. The solid line arrows describe issuing of integrated loyalty points to the customer 500 and the broken lines describe the redemption of integrated loyalty points by the customer 500, FIG. 7 describes loyalty pool 200 as a payment pool.

The primary affiliate server 310 may process issue of integrated loyalty points to the customer 500 and communicate the transaction to the integrated loyalty points management server 100, 400 and the loyalty pool 200.

Also, the affiliate server 310 may process redemption of integrated loyalty points by a customer 500 and communicate the transaction to the integrated loyalty points management server 100, 400 and the loyalty pool 200.

Each of the plurality of primary affiliate servers 310 may issue the integrated loyalty points to customers 500 of the corresponding affiliate according to a loyalty program policy of the corresponding affiliate 300. First, the primary affiliate server 310 may communicate to the loyalty integrated management server 100 a request to purchase a predetermined amount of integrated loyalty points and deposit an amount of money equivalent to the predetermined amount. Then, the loyalty pool 200 may approve the deposit and communicate the approval to the integrate loyalty points management server 100, which in turn approves issuing the loyalty points to the affiliate server 310. Accordingly, the primary affiliate 300 may secure acquisition of integrated loyalty points in advance of any customer purchase. Issued integrated loyalty points may be stored in a membership card or a smart card having a membership card function 501. The issued loyalty may alternatively or additionally stored on another personal electronic device 502.

The integrated loyalty points earned by one of the customers through a transaction or transactions with one or more of the primary affiliates 300 may be redeemed for goods, services, or cash. A customer may earn integrated loyalty points at one or more of any of the primary affiliates 300 and redeem the earned points at one or more of any of the primary affiliates 300.

The loyalty pool 200 may include a server having a processor 210 and a data storage medium 220. The loyalty pool 200 may deposit or withdraw money from an account associated with a bank, an insurance company, or a security corporation.

As shown in FIG. 7, when the customer 500 redeems integrated loyalty points to make payment to a primary affiliate 300, the primary affiliate server 310 may request redeemed integrated loyalty points be exchanged for cash and communicate integrated loyalty point information received from the customer 500 to the integrated loyalty points management server 100, which may verify authenticity of the integrated loyalty point. The integrated loyalty points management server 100 may then request payment to the loyalty pool 200. Subsequently, the loyalty pool 200 may transfer a corresponding amount of predeposited cash to the affiliate.

Table 1 describes some of the advantages of this embodiment of the invention over other integrated loyalty points systems.

TABLE 1

| Classification | System of present invention | Other point system |
|---|---|---|
| Network type | Guarantee independence of | Dependent type in which members concentrate |
| vs | affiliate | on point site |
| Centralized type | Make payment without | Request providing member personal |
| | registration of member personal | information to point using customer |
| | information | Access and move via point site |
| | Access and moves to all affiliates | |
| Cashability | Value guarantee type in which | No systematic and technological device for |
| vs | cash equivalent to point is | value guarantee |
| simple point | deposited in bank | Many limits in saving and use |
| | Negotiability in which points may | Restriction of minimum amount of money, |
| | be obtained and used in all | impossible mixed payment, and impossible |
| | affiliates | transfer |
| | Division payment, mixed payment | |
| | of other payment means, and | |
| | transferable | |
| High Tech | Implementation of perfect security | Low reliability for security |
| vs | technology as security special | Limit in existing planar marketing |
| Low Tech | enterprise | Limit in extensibility due to no related art |
| | Stereoscopic marketing solution | |
| | using electronic wallet technology | |
| | Possessing related art such as IC | |
| | card, heterogeneous DB real-time | |
| | search, etc., | |

Thus, the customer 500 may be offered expanded flexibility in being able to use integrated loyalty points at any of the primary affiliates 300, which in turn is also beneficial to the primary affiliates 300.

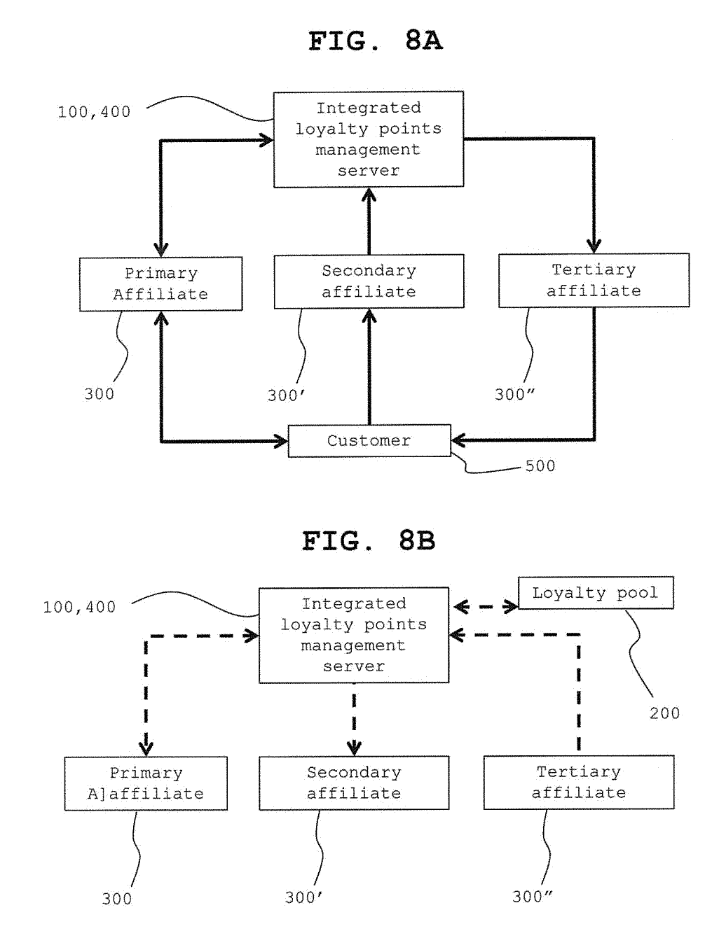

As shown in FIGS. 8A and 8B, according to another embodiment of the present invention, the system for integrated management of loyalty points may further include a secondary affiliate server 310′, wherein the secondary affiliate server 310′ processes a secondary purchase made by a customer 500 from a secondary affiliate 300′ using integrated loyalty points granted by one or more of the affiliates 300. A secondary purchase is defined as a purchase made using integrated loyalty points at a secondary affiliate 300′. FIG. BA diagrams flow of integrated loyalty points and FIG. 8B diagrams flow of money as payment for integrated loyalty points. Herein, the secondary affiliate server 310′ may communicate the secondary purchase with the integrated loyalty points management server 100, 400 to exchange integrated loyalty points used by the customer 500 for cash withdrawn from the account associated with the loyalty pool 200. Herein, unlike affiliate 300, the secondary affiliate 300′ does not grant integrated loyalty points to customers 500 for purchases. Accordingly, the secondary affiliate 300′ may participate in the integrated loyalty points management system without issuing integrated loyalty points to customers 500.

The system for integrated management of loyalty points may further include a tertiary affiliate server 310″, wherein the tertiary affiliate server 310″ processes a tertiary transaction at a corresponding tertiary affiliate 300″ and communicates with the integrated loyalty points management server 100, 400 to grant integrated loyalty points based on the tertiary transaction. Herein, a tertiary transaction is defined as a transaction at a tertiary affiliate 300″ wherein the customer 500 earns integrated loyalty points according to a policy of the tertiary affiliate 300″. The tertiary affiliate server 300″ may not process a redemption of integrate loyalty points by the customer at the tertiary affiliate 300″. Accordingly, a merchant or service provider may participate in the integrated loyalty points program without accepting redemption of loyalty points.

Similar to the affiliate server 310, the tertiary affiliate server 310″ may communicate with the integrated loyalty points management server 100, 400 a purchase request for purchasing a predetermined amount of integrated loyalty points and transmit a deposit to the loyalty pool 200. The loyalty pool 200 may confirm the deposit to the integrated loyalty points management server 100, 400, and the loyalty points management server 100, 400 may issue the predetermined amount of integrated loyalty points to the primary affiliate 300.

According to the present invention, the primary affiliate server 300 may also communicate with the integrated management server 100, 400, which may process an exchange of integrated loyalty points for loyalty points of a non-integrated loyalty points system according to a predetermined exchange rate.

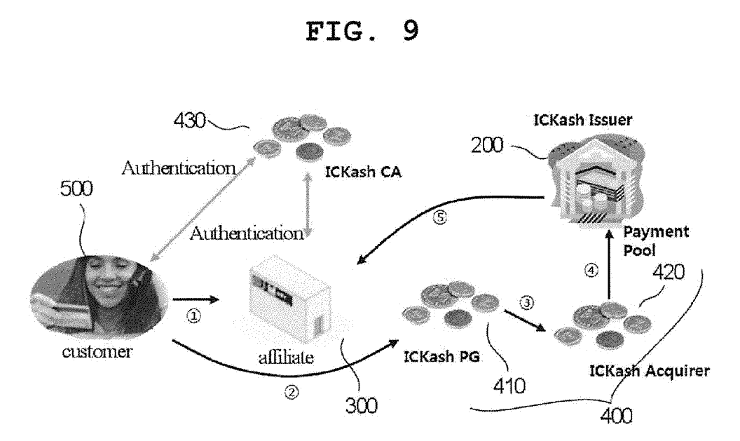

FIGS. 9-12 describe another embodiment of the invention, in which the integrated loyalty points management server 400 may include a payment gateway 410 for receiving payment instruction from the customer 500 and an integrated loyalty points acquirer 420 for receiving a payment request from the payment gateway 410 and requesting payment from the loyalty pool 200. Separately, a certificate authority 430 may certify the transaction between the customer 500 and the primary affiliate 300 as shown in FIG. 9.

Herein, each of the payment gateway 410, the loyalty points acquirer 420, and the certificate authority 430 may include a server to carry out necessary actions.

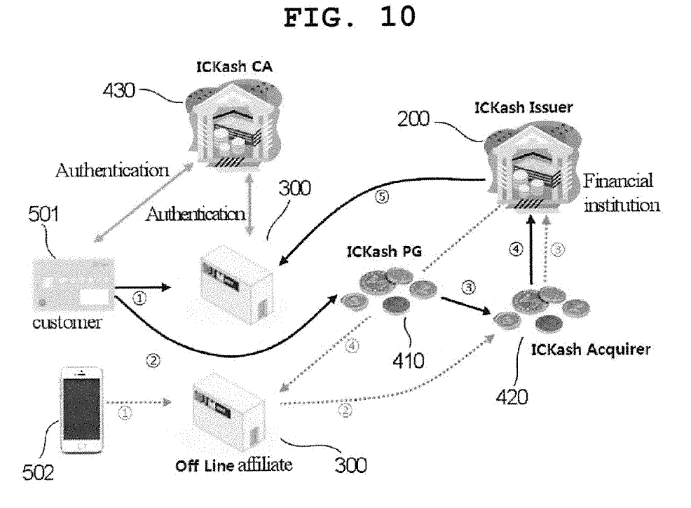

FIG. 10 includes an example in which offline transactions between the customer 500 and the primary affiliate 300 may be made when the smart card 501 or other personal electronic device 502, which store integrated loyalty point information is adapted to operate offline. The broken line in FIG. 10 diagrams an offline payment of the customer 500 with the affiliate 300 using integrated loyalty points. The integrated loyalty points acquirer 420 communicates with the primary affiliate 300 to exchange redeemed integrated loyalty points for cash from the loyalty pool 200.

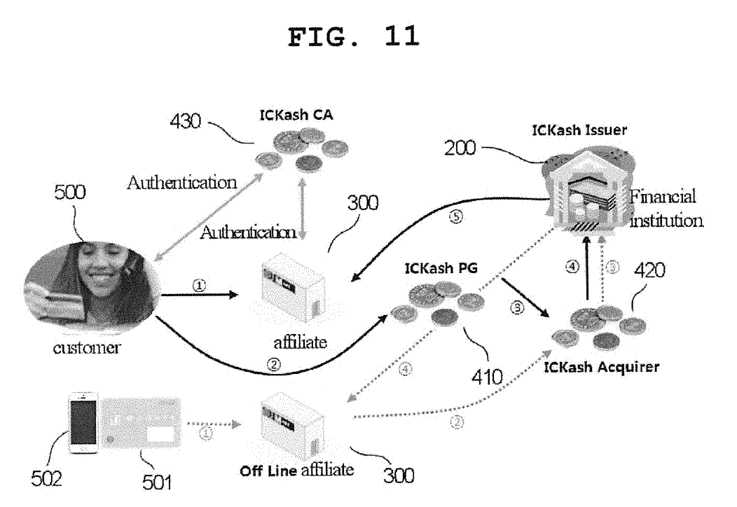

FIG. 11 illustrates an embodiment of integrated loyalty points as electronic money. Herein, integrated loyal points stored on the smart card 501 or other personal electronic device 502 may be immediately exchanged for cash.

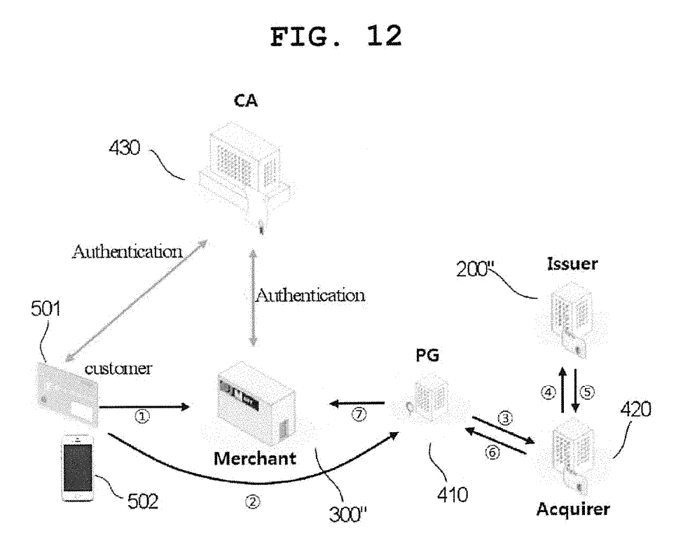

FIG. 12 diagrams a modified example of the previous embodiment. A customer 500 using a smart card 501 or other personal electronic device 502 may request a purchase using integrated loyalty points to an primary affiliate 300. When the customer and send payment information to a payment gateway 410. Then, the payment gateway 410 may request to the integrated loyalty points acquirer 420 to purchase the redeemed points. The acquirer 420 may then request the payment from the loyalty pool 200, which verifies authenticity of the integrated loyalty points and transfers money to the acquirer 420, which in turn transfers the money to the payment gateway, which in turn processes the payment to the affiliate 300. The certification authority 430 may perform additional authentication of the integrated loyalty points.

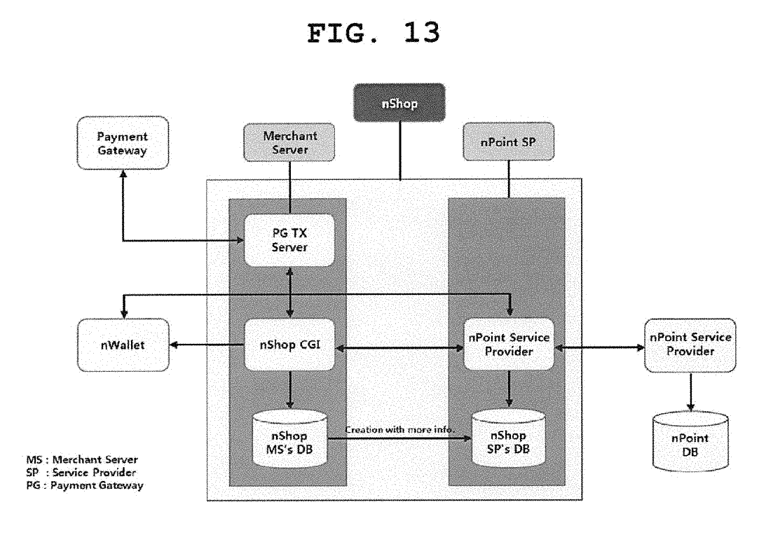

In this case, as a resource of a configuration for Internet connection of the loyalty integrated management system 400, as illustrated in FIG. 13, three components including (1) a smart card of the customer, (2) a service provider mounted on the affiliate, and (3) a service provider positioned in the ICKash system are provided.

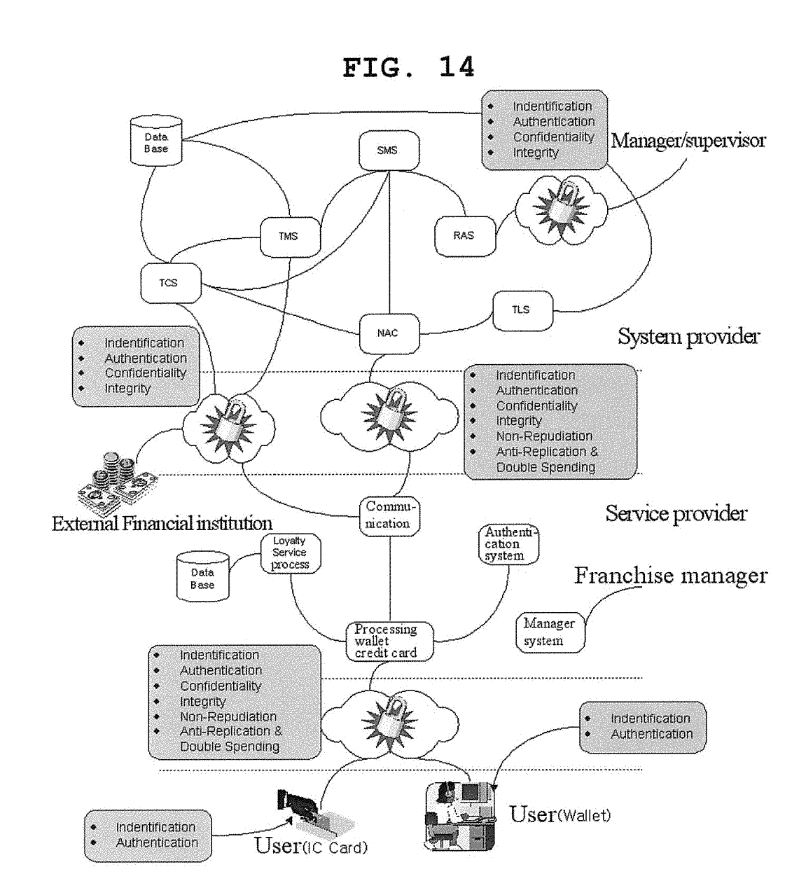

FIG. 14 is a schematic view for describing matters regarding security of the system for integrated management of a loyalty points according to the present invention. The system of the present invention adopts a security method through encryption and electronic signature methods appropriate to all systems by an access method to the electronic money. Detailed security types and solving methods are required, which are shown in [Table 2].

TABLE 2

| Type of security | Solving method |
|---|---|
| Identity & Authentication | Challenge using ID & Password & D Key |
| Confidentiality | Encryption using Session Key |
| Integrity | Message Hash |
| Non-repudiation | Using Digital Signature in |
| | Ordering Information |
| Anti-Replication & Double | Nonce |
| spending | |

According to another embodiment of the present invention, a system for integrated management of loyalty points may include a plurality of primary affiliate servers 310, an integrated loyalty points management server 100, 400, and a loyalty pool. Each primary affiliate server 310 may be associated with a corresponding primary affiliate 300. Each primary affiliate server 310 may manage a customer database (DB) 350 of the primary affiliate 300 stored on the computer-readable medium. As customer information is updated, the primary affiliate server 300 may update the customer DB 350 accordingly. The integrated loyalty points management server 100, 400 may communicate with the primary affiliate servers 310 and manage an integrated customer database 350. The integrated loyalty points management server 100, 400 may manage a plurality of loyalty points systems, wherein each affiliate 300 issues loyalty points corresponding to one of the loyalty points systems. The primary affiliate server 310 may process issue of loyalty points to a customer 500 and communicate the transaction to the integrated loyalty points management server 100, 400 and the loyalty pool 200. Also, the primary affiliate server 310 may process redemption of loyalty points by a customer 500 and communicate the transaction to the integrated loyalty points management server 100, 400 and the loyalty pool 200.

Each of the plurality of primary affiliate servers 310 may issue loyalty points to customers 500 of the corresponding primary affiliate according to a loyalty program policy of the corresponding primary affiliate 300.

The loyalty points earned by one of the customers through a transaction or transactions with one or more of the primary affiliates 300 may be redeemed for goods, services, or cash. A customer may earn loyalty points at one or more of any of the primary affiliates and redeem the earned points at one or more of any of the affiliates.

Loyalty points of one loyalty points system may be exchanged for loyalty points of another loyalty points system according to values of the loyalty points; the primary affiliate server may communicate with the integrated loyalty points. management server 100, 400, which may process such an exchange of loyalty points.

The loyalty pool 200 of the present embodiment may include a server having a processor 210 and a data storage medium 220. The loyalty pool 200 may deposit or withdraw money from an account associated with a bank, an insurance company, or a security corporation.

The system for integrated management of loyalty points may further include a secondary affiliate server 310′, wherein the secondary affiliate server 310′ processes a secondary purchase made by a customer 500 from a secondary affiliate 300′ using loyalty points granted by one or more of the affiliates 300. Herein, the secondary affiliate server 310′ may communicate the secondary purchase with the integrated loyalty points management server 100, 400 to exchange loyalty points used by the customer 500 for cash withdrawn from the account associated with the loyalty pool 200.

The integrated loyalty points management server 100, 400 may process an exchange of the loyalty points earned by the customer 500 through the transaction from the affiliate server 310 for integrated loyalty points according a policy of the corresponding affiliate 300.

Loyalty points earned by the customer 500 through transactions from the primary affiliate 300 may be recorded on a data storage medium of a personal electronic device 501, 502 of the customer 500. The personal electronic device may be a smartphone, a computer tablet, or the like. Preferably, the personal electronic device may be a smart card 501.

The smart card 501 may have a display. The smart card may include input buttons and a digital display, which may display a loyalty points balance.

The loyalty points earned by the customer 500 through the transaction with the affiliate 300 may have a monetary value determined by the affiliate 300. The monetary value may alternatively be determined by a corresponding loyalty points system policy.

Additionally, loyalty points earned by the customer 500 through a transaction with another of the plurality of affiliates 300 may have a different monetary value.

According to another embodiment of the present invention, a method for integrated management of loyalty points may include: making a deposit, by a primary affiliate server 310 of a primary affiliate 300 to a loyalty pool 200, of an amount of money equivalent to a number of integrated loyalty points; requesting, by the primary affiliate server 310 to an integrated loyalty points management server 100, 400, purchase of the number of integrated loyalty points; authenticating, by the loyalty pool 200 to the integrated loyalty points management server 100, 400, the deposit made by the affiliate and updating a balance of the affiliate 300; approving, by the integrated loyalty points management server 100, 400 to the primary affiliate server 310, issuing of the number of integrated loyalty points; and transferring, by the primary affiliate server 310 to a customer 500, a quantity of integrated loyalty points as a reward for a purchase of goods and services. The quantity of loyalty points rewarded to the customer 500 may be predetermined by a policy of the affiliate 300. The balance that is updated may be a monetary balance of an account associated with the loyalty pool 200 corresponding to the primary affiliate 300.

The loyalty points may be integrated loyalty points as in the above embodiment. Alternatively, the loyalty points may correspond to another loyalty point system.

The present invention may provide steps for an primary affiliate server 310 processing redemption of loyalty points to exchange the redeemed loyalty points for money. According to this embodiment, the method for integrated management of loyalty points may further include: requesting, by the primary affiliate server 310 to the integrated loyalty points management server 100, 400, when the customer 500 purchases goods or services from the primary affiliate 300 by redeeming loyalty points, exchange of redeemed loyalty points for a predetermined amount of money; certifying, by the integrated loyalty points management server 100, 400, authenticity of the redeemed loyalty points; requesting, by the integrated loyalty points management server 100, 400 to the loyalty pool 200, transfer of a corresponding amount of money, which may be determined by the policy of the affiliate, from the loyalty pool 200 to the affiliate server 310; and transfer of the corresponding amount of money from the loyalty pool 200 to the affiliate server 310.

The present invention may also provide a method for purchasing loyalty points by a secondary affiliate 300′. The method integrated management of loyalty points may further include: requesting, by a secondary affiliate server 310′ to the integrated loyalty points management server 100, 400, when the customer 500 purchases goods or services from a secondary affiliate 300′ by redeeming loyalty points, exchange of redeemed loyalty points for money in an amount determined by a policy of the secondary affiliate 300′; authenticating, by the integrated loyalty points management server 100, 400, the redeemed loyalty points; requesting, by the integrated loyalty points management server 100, 400 to the loyalty pool 200, transfer of a corresponding amount of money as determined by the policy of the secondary affiliate 300′ from the loyalty pool 200 to the secondary affiliate server 310′; and transfer of the corresponding amount of money from the loyalty pool 200 to the secondary affiliate server 310′.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A system for integrated management of loyalty points, the system comprising:
a plurality of primary affiliate servers (310), each primary affiliate server (310) managing a customer database (350) with customer information for a corresponding primary affiliate (300) and storing the customer database (350) on a data storage medium of the primary affiliate server (310);
an integrated loyalty points management server (100, 400) communicating with the primary affiliate servers (310), managing an integrated customer database (150) of the primary affiliate customer databases (350), and managing integrated loyalty points earned by customers (500) of the primary affiliates (300), each primary affiliate (300) granting the integrated loyalty points to the customer (500) for a purchase; and
a loyalty pool (200) comprising a processor (210) and a data storage medium (220), the loyalty pool (200) communicating with the integrated loyalty points management server (100, 400) and the primary affiliate servers (310) for issuing the integrated loyalty points earned by customers (500), wherein each of the plurality of primary affiliate servers (310) grants the loyalty points to customers (500) of the corresponding primary affiliate (300) according to a loyalty program policy of the corresponding primary affiliate (300),
wherein the integrated loyalty points earned by one of the customers (500) through a transaction or transactions with one or more of the primary affiliates (300) are redeemable for goods, services, or cash,
wherein each of the affiliate servers (310) processes each transaction at the corresponding primary affiliate (300) and communicates with the integrated loyalty points management server (100, 400) to grant integrated loyalty points based on the transaction,
wherein each of the primary affiliate servers (310) processes a redemption of integrated loyalty points and communicates the redemption to the integrated loyalty points management server (100, 400), and the integrated loyalty points management server (100, 400) communicates with the loyalty pool (200) to accept redeemed integrated loyalty points and transfer cash from an account associated with the loyalty pool (200) to the corresponding, primary affiliate (300).

2. The system for integrated management of loyalty points of claim 1, further comprising a secondary affiliate server (310′),
wherein the secondary affiliate server (310′) processes a secondary purchase made by a customer (500) from a secondary affiliate (300′) using integrated loyalty points granted by one or more of the primary affiliates (300),
wherein the secondary affiliate server (310′) communicates the secondary purchase with the integrated, loyalty points management server (100, 400) to exchange integrated loyalty points used by the customer (500) for cash withdrawn from the account associated with the loyalty pool (200),
wherein the secondary affiliate (300′) does not grant loyalty points to customers (500).

3. The system for integrated management of loyalty points of claim 2, wherein the integrated loyalty points management server (400) comprises:
a payment gateway (410) for receiving payment instruction information from the customer (500);
an integrated loyalty points acquirer (420) for receiving a payment request from the payment gateway (410), requesting a payment from the loyalty pool (200); and
a certificate authority (430) for certifying the transaction between the customer (500) and the primary affiliate (300).

4. The system for integrated management of loyalty points of claim 1, wherein the primary affiliate server (310) communicates with the integrated loyalty points management server (100, 400) a purchase request for purchasing a predetermined amount of integrated loyalty points and transmits a deposit to the loyalty pool (200), the loyalty pool confirms the deposit to the integrated loyalty points management server (100, 400), and the loyalty points management server (100, 400) issues the predetermined amount of integrated loyalty points to the primary affiliate (300).

5. The system for integrated management of loyalty points of claim 1, wherein the integrated loyalty points earned by the customer (500) through the transaction from the primary affiliate (300) are recorded on a data storage medium of a personal electronic device.

6. The system for integrated management of loyalty points of claim 5, wherein the personal electronic device comprises a smart card.

7. The system for integrated management of loyalty points of claim 6, wherein the smart card includes a digital display for displaying a loyalty points balance.

8. The system for integrated management of loyalty points of claim 1, wherein the integrated loyalty points earned by the customer (500) through the transaction with the primary affiliate (300) have a predetermined monetary value.

9. The system for integrated management of loyalty points of claim 1, further comprising a tertiary affiliate server (310″),
wherein the tertiary affiliate server (310″) processes a tertiary transaction at a corresponding tertiary affiliate (300″) and communicates with the integrated loyalty points management server (100, 400) to grant integrated loyalty points based on the tertiary transaction,
wherein the tertiary affiliate server (310″) does not process a redemption of integrated loyalty points attempted by the customer at the tertiary affiliate (300″).

10. The system for integrated management of loyalty points of claim 1, wherein one or more affiliates (300, 300′, 300″) issue non-integrated loyalty points, and the integrate loyalty points server (100, 400) processes an exchange of non-integrated loyalty points for integrated loyalty points according to a predetermined exchanged rate.

11. A system for integrated management of loyalty points, the system comprising:
a plurality of primary affiliate servers (310), each primary affiliate server (310) managing a customer database (350) with customer information for a corresponding primary affiliate (300) and storing the customer database (350) on a data storage medium of the primary affiliate server (310), wherein each primary affiliate (300) issues loyalty points corresponding to one of a plurality of loyalty points systems;
an integrated loyalty points management server (100, 400) communicating with the primary affiliate servers (310), managing an integrated customer database (150) of the primary affiliate customer databases (350); and
a loyalty pool (200) comprising a processor (210) and a data storage medium (220), the loyalty pool (200) communicating with the integrated loyalty points management server (100, 400) and the primary affiliate servers (310), which issue the loyalty points earned by customers (500),
wherein each of the plurality of primary affiliate servers (310) issues the loyalty points to customers (500) of the corresponding primary affiliate (300) according to a loyalty program policy of the corresponding primary affiliate (300),
wherein the loyalty points earned by one of the customers (500) through a transaction with one of the primary affiliates (300) are redeemable for goods, services, or cash,
wherein each of the primary affiliate servers (310) processes the transaction at the corresponding primary affiliate (300) and communicates with the integrated loyalty points management server (100, 400) to grant loyalty points based on the transaction,
wherein each of the primary affiliate servers (310) processes a redemption of loyalty points and communicates the redemption to the integrated loyalty points management server (100, 400), and the integrated loyalty points management server (100, 400) communicates with the loyalty pool (200) to accept redeemed loyalty points and transfer cash from an account associated with the loyalty pool (200) to the corresponding primary affiliate (300),
wherein one or more affiliates (300, 300′, 300″) issue non-integrated loyalty points, and the integrate loyalty points server (100, 400) processes an exchange of non-integrated loyalty points for integrated loyalty points according to a predetermined exchanged rate.

12. The system for integrated management of loyalty points of claim 11, further comprising a secondary affiliate server (310′),
wherein the secondary affiliate server (310′) processes a secondary purchase made by a customer (500) from a secondary affiliate (300′) using loyalty points granted by one of the affiliates (300),
wherein the secondary affiliate server (310′) communicates the secondary purchase with the integrated loyalty points management server (100, 400) to exchange loyalty points used by the customer (500) with cash withdrawn from the account associated with the loyalty pool (200),
wherein the secondary affiliate (310′) does not grant loyalty points to customers.

13. The system for integrated management of loyalty points of claim 11, wherein the integrated loyalty points management server (100, 400) processes an exchange of the loyalty points earned by the customer (500) through the transaction from the affiliate server (310) for integrated loyalty points according a policy of the corresponding affiliate (300).

14. The system for integrated management of loyalty points of claim 11, wherein the loyalty points earned by the customer (500) through the transaction from the primary affiliate (300) are recorded on a data storage medium of a personal electronic device, wherein the personal electronic device comprises a smart card.

15. The system for integrated management of loyalty points of claim 14, wherein the smart card includes a digital display for displaying a loyalty points balance.

16. The system for integrated management of loyalty points of claim 11, wherein the loyalty points earned by the customer (500) through the transaction with the primary affiliate (300) have a monetary value determined by the primary affiliate (300).

17. The system for integrated management of loyalty points of claim 16, wherein loyalty points earned by the customer (500) through a transaction with another primary affiliate (300) have a different monetary value.

18. A method for integrated management of loyalty points, the method comprising:
making a deposit, by a primary affiliate server (310) of a primary affiliate (300) to a loyalty pool (200), of an amount of money equivalent to integrated loyalty points;
requesting, by the primary affiliate server (310) to an integrated loyalty points management server (100, 400), purchase of the number of integrated loyalty points;
authenticating, by the loyalty pool (200) to the integrated loyalty points management server (100, 400), the deposit made by the primary affiliate (300) and updating a balance of the primary affiliate (300);
approving, by the integrated loyalty points management server (100, 400) to the primary affiliate server (310), issuing the number of integrated loyalty points; and
transferring, by the primary affiliate server (310) to a customer (500), a quantity of integrated loyalty points as a reward for a purchase of goods and services,
wherein the quantity of integrated loyalty points rewarded to the customer is predetermined by a policy of the primary affiliate (300).

19. The method of claim 18, further comprising:
requesting, by the primary affiliate server (310) to the integrated loyalty points management server (100, 400), when the customer 500 purchases goods or services from the primary affiliate (300) by redeeming integrated loyalty points, exchange of redeemed integrated loyalty points for a predetermined amount of money;
certifying, by the integrated loyalty points management server (100, 400), authenticity of the integrated loyalty points;
requesting, by the integrated loyalty points management server (100, 400) to the loyalty pool (200), transfer of a corresponding amount of money as determined by the policy of the affiliate from the loyalty pool (200) to the affiliate (300); and
transfer of the corresponding amount of money from the loyalty pool (200) to the affiliate server (310).

20. The method of claim 19, further comprising:
requesting, by a secondary affiliate server (310′) of a secondary affiliate (300′) to the integrated loyalty points management server (100, 400), when the customer 500 purchases goods or services from the secondary affiliate (300′) by redeeming loyalty points, exchange of redeemed loyalty points for money in an amount determined by a policy of the secondary affiliate (300′);
authenticating, by the integrated loyalty points management server (100, 400), the redeemed loyalty points;
requesting, by the integrated loyalty points management server (100, 400) to the loyalty pool (200), transfer of a corresponding amount of money from the loyalty pool (200) to the secondary affiliate server (310′); and
transfer of the corresponding amount of money from the loyalty pool (200) to the secondary affiliate server (310′).
